(19) United States
(12) Patent Application Publication
(10) Pub. No.: US 2006/0144417 A1
(43) Pub. Date: Jul. 6, 2006

(54) Method of lowering contact angles on an optical film surface

(75) Inventors: Yi-Ping Wang, Ping Chen (TW); Yao-Chung Cheng, Ping Chen (TW); Ming-Chih Shih, Ping Chen (TW)

Correspondence Address: NIKOLAI & MERSEREAU, P.A., 900 SECOND AVENUE SOUTH, SUITE 820, MINNEAPOLIS, MN, 55402, US

(73) Assignee: OPTIMAX TECHNOLOGY CORPORATION, Ping Chen (TW)

(21) Appl. No.: 11/241,453

(22) Filed: Sep. 29, 2005

(30) Foreign Application Priority Data
Dec. 16, 2004 (TW) 093139163

(51) Int. Cl. B08B 6/00

(52) U.S. Cl. 134/1.1; 134/26

(57) ABSTRACT

The present invention relates to a method of lowering contact angles on an optical film surface, especially a cellulose acetate butyrate film. The optical film is first cleaned by alkaline purge and acidic purge to remove tiny impurities on the surface, and then treated with non-thermal plasmas to lower the contact angles on the optical film so as to increase adherence possibility.

### BACKGROUND OF THE INVENTION

1. Field of the Invention

The present invention relates to a method of lowering contact angles on an optical film surface, and more particularly to a method of lowering contact angles on a cellulose acetate butyrate (CAB) film surface.

2. Description of Related Art

A polarizer is an indispensable critical component in a liquid crystal display (LCD) including Twisted Nematic LCD (TN LCD), Super Twisted Nematic LCD (STN LCD), and Thin Film Transistor LCD (TFT LCD). With the LCD industry booming, the demand for polarizers is substantially growing in the market. The function of a polarizer is to have light of which an electric field oscillates in a certain direction to pass through the polarizer and filter off light of which the electric field oscillates in other directions, so as to generate polarized light. In an LCD display, two polarizers are disposed respectively on the opposite sides, that is, an upper side and a lower side, of a LC unit and configured perpendicularly with each other in respect of the light polarized direction, such that light passing through the lower polarizer can not pass through the upper polarizer so as to present dark color on a panel. However, providing voltage on the LC unit to adjust and control the orientation of the LC can lead polarized light passing through the lower polarizer to rotate 90 degrees to pass through the upper polarizer, so as to present bright white color on the panel. With such performance, the panel can present variations of brightness and darkness. In short, the polarizer is used to make natural light become polarized light to pass into the LC unit.

Basically the polarizer comprises multi-layers, in which polyvinyl alcohol (PVA) film is usually provided as polarized substrate due to its polarization effect on the basis of molecular stretching characteristic, and two triacetyl cellulose (TCA) films are respectively attached on the opposite sides of the PVA film after the PVA film is stretched, to prevent the PVA film from shrinking.

The polarizer can be not only used on an LCD but also applied on sunglasses, by just replacing the TAC films with cellulose acetate butyrate (CAB) films. The chemical structures of CAB and TCA are similar, as drawn as follows: 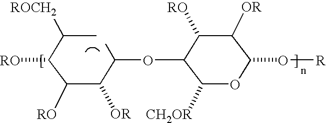
R=COCH₂CH₂CH₃ or H for CAB;
R=COCH₃ for TCA.

In practical manufacturing optical films, such as TCA or CAB films, it is found that if the critical contact angles on the optical film surface are over 40 degrees, the adherence between optical films fails easily. There is a conventinal process for lowering contact angles on the TAC film surface, which mainly comprises the following steps: preparing an original TAC film; washing the original TAC film with alkaline chemical compound for a predetermined time; washing the TAC film with pure water to clean the alkaline chemical compound residue thereon; washing the TAC film with sulfuric acid; washing the TAC film with pure water to clean the sulfuric acid residue thereon; drying the TAC film in a vacuum oven. Through these steps, tiny particles can be removed, and the contact angles on the TAC film are decreased to about 20 degrees. However, as to a CAB film treated with the same steps, the contact angles on the CAB film cannot be decreased less than 35 degrees due to the greater bind energy of the functional group of the CAB film. FIG. 1 shows experimental data of contact angles on the CAB film treated with the conventional pretreatment process. It is found that after the CAB film is treated with the conventional pretreatment process, however, without the drying step, the average contact angles are 61.536 degrees on a glue-inclusive surface of the CAB film and 51.758 degrees on a non-glue-inclusive surface of the CAB film, respectively; and after the CAB film is further treated with the drying step, the average contact angles are 50.426 degrees on a glue-inclusive surface of the CAB film and 55.436 degrees on a non-glue-inclusive surface of the CAB film, respectively. It can be seen that the conventional pretreatment process cannot decrease the contact angles on the CAB film because the surfaces of the CAB film are too smooth, and thus, it is necessary to improve the conventional pretreatment process.

### SUMMARY OF THE INVENTION

An objective of the present invention is to provide a method of lowering contact angles on an optical film surface, especially a CAB film. The optical film is first subjected to alkaline purge and acid purge steps to remove impurities on the original optical film, but these steps cannot decrease the contact angles thereon. Then the optical film is subjected to a drying step and then is put statically for an appropriate period, and finally is treated with non-thermal plasmas (NTPS) to roughen the opposite surfaces of the optical film and decrease the contact angles thereon.

The lower contact angles resulted from NTPS treatment are only maintained provisionally, which is because the molecular structure on the optical film surface is altered just for a while, and after that time, the molecular structure thereon will recover as not being treated with NTPS.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a table of experimental data of contact angles on the CAB film treated by the conventional pretreatment process; and

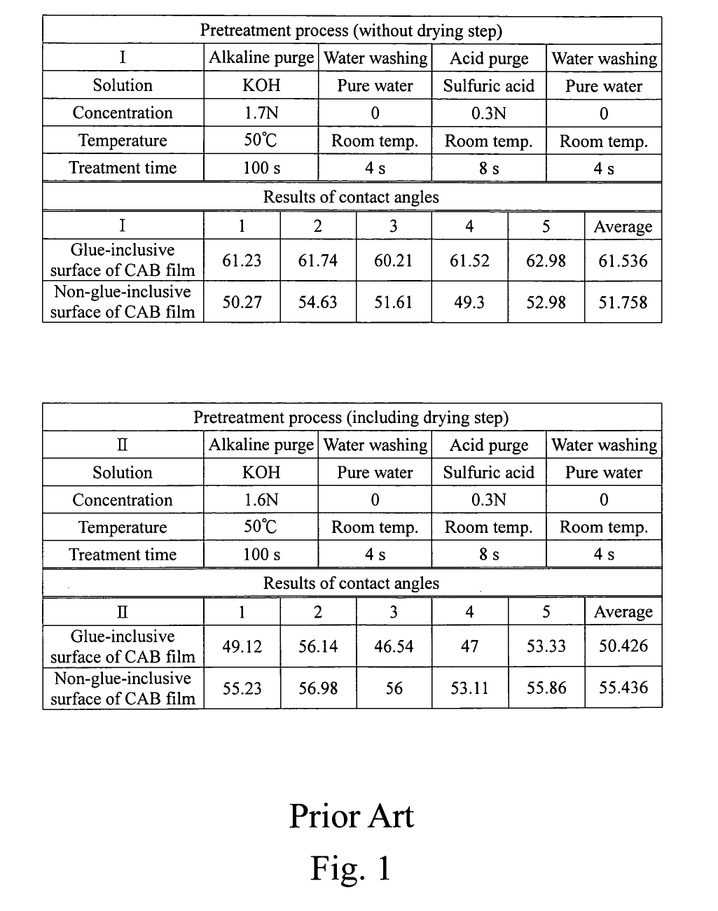

FIG. 2 is a table of experimental data of contact angles on the CAB film treated by the present invention.

### DETAILED DESCRIPTION OF THE PREFFERED EMBODIMENT

A method of lowering contact angles on an optical film surface in accordance with the present invention comprises the following steps:

a) preparing an original optical film;

b) washing the original optical film with alkaline chemical compound (such as potassium hydroxide);

c) washing the optical film with pure water to clean the alkaline chemical compound residue thereon;

d) washing the optical film with acid solution (such as sulfuric acid);

e) washing the optical film with pure water to clean the acid solution residue thereon;

f) drying the optical film in a vacuum oven;

g) placing the optical film for an appropriate time of period; and

h) treating the optical film with non-thermal plasmas (NTPS).

The steps (a)˜(f) are the same as the conventional pretreatment as mentioned above for the TAC film. Such steps are mainly to remove tiny particles or impurities attached on the original optical film to ward off ill effects in the subsequent adherence. The step (h) can alter the molecular structure of the optical film surface to roughen the surface of the optical film so as to decrease contact angles thereon. The detailed NTPS treatment will be clearly described as follows.

If an electron is accelerated by high voltage through increasing its kinetic energy, such an electron with high kinetic energy is called an energetic electron. When the energetic electron moves in space, it always will collide with an air molecule along with energy transfer simultaneously, wherein there are two kinds of collisions, that is, elastic collision and inelastic collision. If elastic collision occurs between the energetic electron and the air molecule, the quantity of the energy transfer is in inverse proportion to the mass:

$$\frac{{E}_{molecule}}{{E}_{e}} ≅ 4 \frac{{m}_{e}}{{m}_{molecule}} ≅ \frac{2.17 \times {10}^{- 3}}{{M}_{w}}$$

Presuming E^{e} being 5 eV, the oxygen molecule (M_{w}=32) can just accept less than 0.00004 eV, and even hydrogen molecule (M_{w}=2) only accepts 0.005 eV. Thus, it can be seen that when elastic collision occurs between the energetic electron and the air molecule, the energetic electron can only provide a bombardment [Does ‘bit’ refer to an electronic bit, or simply ‘a very small amount of’? If the latter, then use that, rather than ‘a bit’.] energy to the air molecule, and such provided energy is too small to dissociate or ionize the air molecule. However, if the energetic electron and the air molecule proceed inelastic collision with each other, the kinetic energy of the energetic electron can almost totally be transferred to the air molecule as internal energy; and if the transferred energy is large enough, it can excite, dissociate, or ionize the air molecule to become a highly active particle such as metastable molecule, radical, or ion. The combination of electrons, radicals, ions, excited molecules and air molecule is so-called plasma.

The particles of the plasma can be grouped into three kinds in light of charges the particles have: (i) positive ions; (ii) electrons and negative ions; and (iii) atoms, radicals, and metastable particles without any charges. If high voltage is provided between two electrodes to form an electric field therebetween, the charged particles existing in the electric field will be accelerated with increased kinetic energy. Since the electrons are of the lightest mass (m_{H}/mₑ=1840), acceleration of the electrons is largest among the charged particles other than electrons, the average velocity of the electrons is much greater than the other charged particles in the plasma. In such situation of particles with varied velocities, inelastic collision between particles easily happens, and the accompanied high-energy transfer can impel chemical reactions to go on.<[?]

Recently, several plasma methods used to eliminate vapor pollutant have been developed in succession, for example, electron beam, corona discharge, microwave, radio frequency, dielectric barrier discharge, etc. The microwave and radio frequency methods are suitably operated in low pressure, while the electron beam, corona discharge, and dielectric barrier discharge methods can effectively discharge in normal atmospheric pressure. In a plasma system, there are two electrodes to provide high voltage to generate a high electric field, such that charged particles in a reactor received in the system will acquire kinetic energy to be accelerated. Since electrons are very light, average velocity of the electrons is far faster than the other particles in the electric field. In such situation, inelastic collision between particles will easily happen to produce high active radicals, and this induces relevant chemical reactions.

The best embodiment of the present invention is adopting corona discharge method that can be operated in normal atmospheric pressure. In order to raise operational pressure, the electric field has to be increased, but generally discharge will become unstable in such high pressure and high electric field, and electric arcs may occur in local positions. To solve such disadvantageous problems, the electrodes are designed in asymmetric manner in the reactor to make discharge stable. According to different power supply styles, there are different corona discharge reactors, such as direct current corona reactor, pulsed corona reactor, etc.

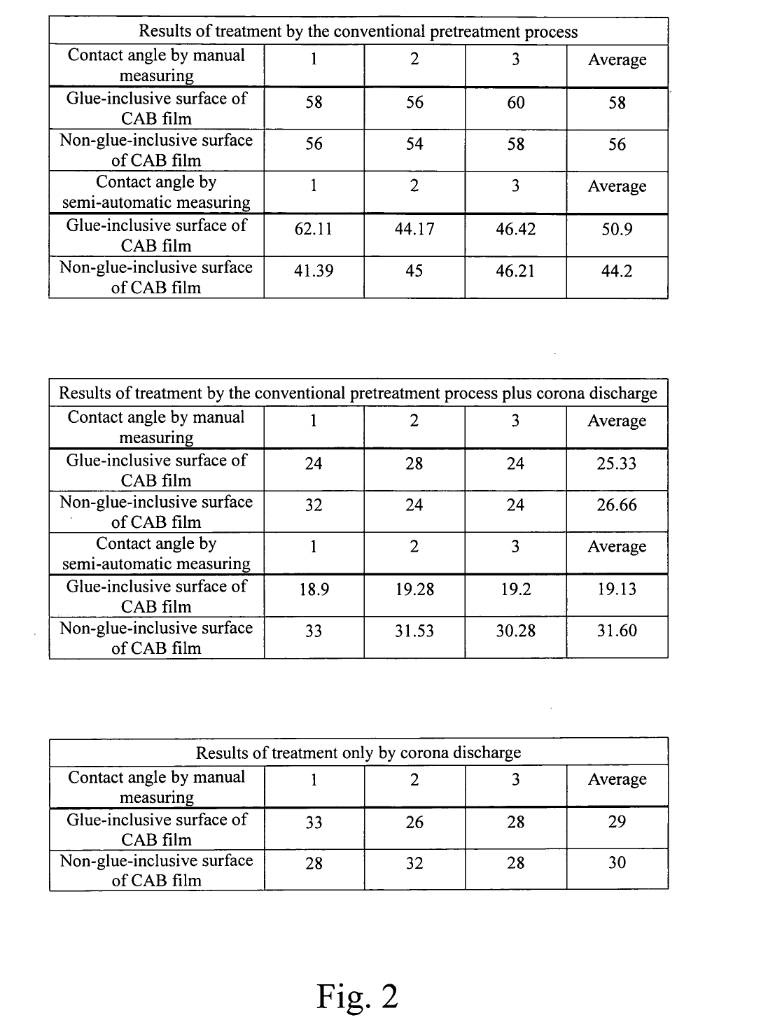

Taking CAB film for example, the corona discharge method used in the present invention is operated in such conditions: power is 500 W; treatment distance from the film is about 1 cm; and treatment velocity is 1.4 m/min. Through such treatment, the CAB film surface will produce high active radicals to promote occurrence of relevant chemical reactions so as to roughen the surface and decrease the contact angles thereon. With reference to FIG. 2, after removing tiny particles and impurities on the film surface by the conventional pretreatment as described above, and using corona discharge method thereafter to treat the CAB film, the contact angles on the CAB film surface are less than critical angle 35 degrees, no matter by manual measurement or semi-automatic measurement, so that the following adherence process will not fail, because of being stripped easily.

In addition, even though the CAB film is not treated by cleaning pretreatment steps and just treated by the corona discharge method, the contact angles decreasing effect still is attained and obvious (as shown in FIG. 2).

The present invention also discovers that using corona discharge method to decrease contact angles on the CAB film is provisional because corona discharge just can make brief change of molecular structure of the CAB film surface. After a while, the molecular structure still will recover like before, so the following adherence process has to be done before the molecules of the CAB film surface return to their original structure.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method of lowering contact angles on an optical film surface, comprising the step:
subjecting an optical film to non-thermal plasmas treatment to alter molecular structure of the optical film surface to decrease the contact angles thereon.

2. The method of lowering contact angles on an optical film surface according to claim 1, wherein before subjecting an optical film to non-thermal plasmas treatment, the method further comprises cleaning steps of washing the optical film by alkaline solution, acid solution and pure water to remove tiny impurities on the optical film surface.

3. The method of lowering contact angles on an optical film surface according to claim 1, wherein the optical film is made of cellulose acetate butyrate.

4. The method of lowering contact angles on an optical film surface according to claim 2, wherein the alkaline solution is potassium hydroxide solution.

5. The method of lowering contact angles on an optical film surface according to claim 2, wherein the acid solution is sulfuric acid solution.

6. A method of lowering contact angles on an optical film surface, comprising following steps:
washing an optical film by alkaline solution, acid solution and pure water to remove tiny impurities on the optical film;
drying the optical film and thereafter placing it for a determined time; and
subjecting the optical film to non-thermal plasmas treatment to alter molecular structure of the optical film surface to decrease the contact angles thereon.

7. The method of lowering contact angles on an optical film surface according to claim 6, wherein the optical film is made of cellulose acetate butyrate.

8. The method of lowering contact angles on an optical film surface according to claim 6, wherein the alkaline solution is potassium hydroxide solution.

9. The method of lowering contact angles on an optical film surface according to claim 6, wherein the acid solution is sulfuric acid solution.
